(19) United States
(12) Patent Application Publication
(10) Pub. No.: US 2003/0204966 A1
(43) Pub. Date: Nov. 6, 2003

(54) Structure tape rule outer housing

(76) Inventor: Cheng-Hui Hsu, Hsin Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/135,515

(22) Filed: May 1, 2002

(51) Int. Cl. G01B 3/10

(52) U.S. Cl. 33/769

(57) ABSTRACT

An improved structure tape rule outer housing, wherein the outer housing of the tape rule is comprised of a left case half, a right case half, and metal case panels to increase gripping friction and usage comfort as well as enhance tape rule design versatility to thereby raise overall practical value.

### BACKGROUND OF THE INVENTION

1) Field of the Invention

The invention herein relates to an improved structure tape rule outer housing, specifically a structure in which the outer housing of the tape rule consists of a plastic material left case half and a right case half having a soft rubber pad covering their upper edges, rear sides, or bottom edges to increase gripping friction and usage comfort. Furthermore, metal case panels are additionally affixed to the exterior sides of the tape rule housing to enhance tape rule design versatility and thereby raise industrial practical value

2) Description of the Prior Art

Referring to FIG. 1, the drawing of a conventional tape rule, the outer housing of the said conventional tape rule 10 is comprised of a left case half 11 and a right case half 12 that are conjoined together, with a ruler blade wound inside the said tape rule. The left case half 11 and the right case half 12 of the conventional tape rule are typically injection-molded of a single grade of plastic material which is more slippery due to low effective grasping friction and, furthermore, the single-grade plastic outer housing has a relatively invariable product structure. However, in the interest of more convenient and practical tape rule usage, the inventor of the invention herein conducted meticulous research and development based on many years of professional manufacturing experience and, furthermore, subjected the results to extensive testing and further refinement to achieve an even higher level of practical value, which finally culminated in the improved structure tape rule outer housing of the invention herein.

### SUMMARY OF THE INVENTION

Therefore, the primary objective of the invention herein is to provide an improved structure tape rule outer housing, wherein the outer housing of the tape rule consists of a plastic material left case half and a right case half having a soft rubber pad covering their upper edges, rear sides, or bottom edges to increase gripping friction and usage comfort and, furthermore, metal case panels are additionally affixed to the exterior sides of the tape rule housing to enhance tape rule design versatility and thereby raise overall practical value.

To enable the examination committee to further understand the structural features and technological content as well as the advantages and innovations of the invention herein, the brief description of the drawings below is followed by the detailed description of the invention herein.

### BRIEF DESCRIPTION OF THE DRAWINGS

FIG. 1 is an isometric drawing of a conventional product.

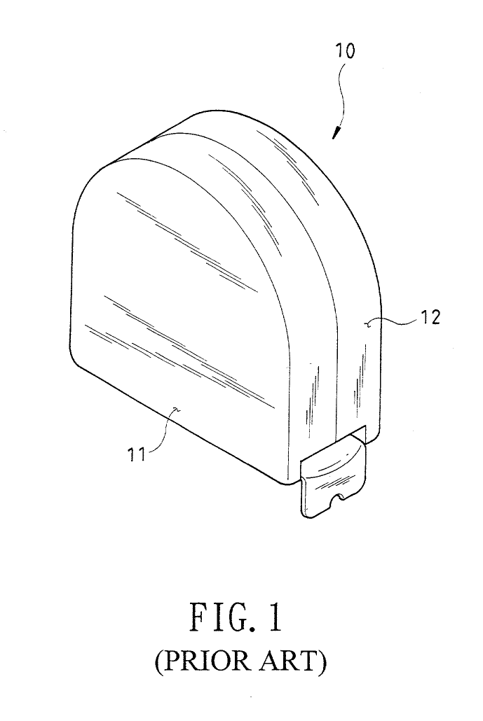

FIG. 2 is an isometric drawing of the invention herein.

FIG. 3 is an exploded drawing of the invention herein.

FIG. 4 is an isometric drawing of another embodiment of the invention herein.

### DETAILED DESCRIPTION OF THE INVENTION

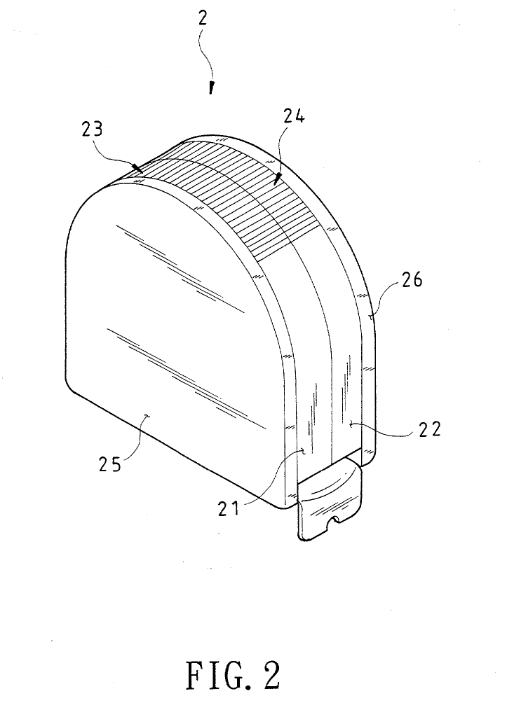

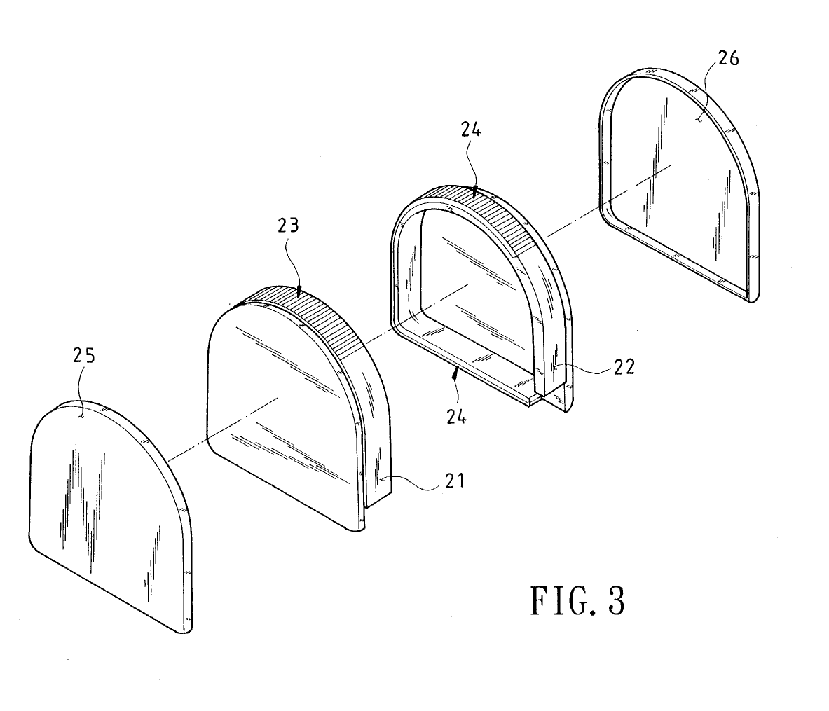

Referring to FIG. 2 and FIG. 3, in the improved structure tape rule outer housing of the invention herein, the outer housing of the said tape rule 2 is comprised of a left case half 21, a right case half 22, and metal case panels 25 and 26, of which:

The left case half 21 is of one-piece plastic construction, with a soft rubber pad 23 covering the upper edge, rear side, or bottom edge of the left case half 21.

The right case half 22 is of one-piece plastic construction, with a soft rubber pad 24 covering the upper edge, rear side, or bottom edge of the right case half 22.

The metal case panel 25 is single section of thin sheet metal unitarily contoured by pressure forming and the metal case panel 25 is affixed to the exterior side of the left case half 21.

The metal case panel 26 is single section of thin sheet metal unitarily contoured by pressure forming and the metal case panel 26 is affixed to the exterior side of the right case half 22.

The surfaces of the said metal panels 25 and 26 can be reticulated (not shown in the drawings) to allow the soft surfaces or rubber pads 23 and 24 of the left case half 21 or the right case half 22 to protrude through the metal panels 25 and 26.

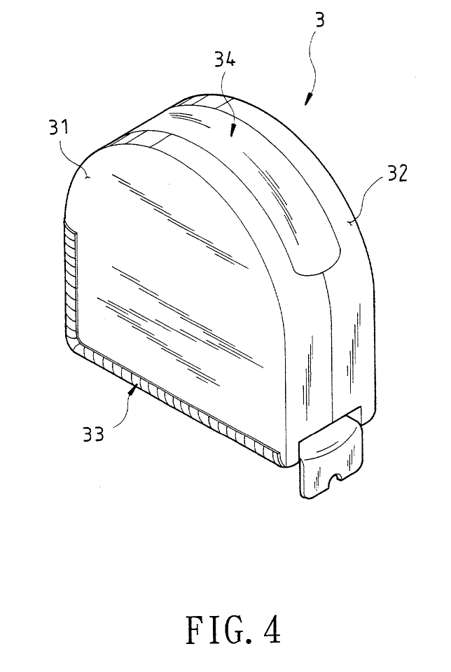

Referring to FIG. 4, in the another embodiment of the invention herein, a single soft rubber pad 33 covers the rear side or the bottom edge of both the left case half 31 and the right case half 32 of the said tape rule 3, while a single metal panel 34 is affixed along the center upper edges of the left case half 31 and the right case half 32.

Given the said structure of the invention herein, since the said tape rule outer housing is plastic at the user grasping area, with the soft rubber pads centered along their exterior sides or upper edges as well as metal panels additionally affixed to them, tape rule housing gripping friction and usage comfort is increased, while tape rule design versatility is enhanced to raise the practical value of such products.

While the preceding detailed description conveys in general a workable embodiment of the present invention, the said embodiment shall not be construed as a limitation of the scope and claims of the invention herein and, furthermore, all adaptations and modifications based on the technology and spirit of the invention herein shall remain protected within the patented scope of the invention herein.

In summation of the foregoing section, since the invention herein is not only of an original spatial arrangement, but also capable of greater functional utility and possesses utmost practical value and, furthermore, the disclosure of an identical or similar product has not been observed in the prevailing market, the present invention is submitted to the examination committee for review and the granting of the commensurate patent rights.

1. An improved structure tape rule outer housing, with the outer housing of the said tape rule comprised of a left case half, a right case half, and metal case panels, of which:
The said left case half is of one-piece plastic construction, with a soft rubber pad covering the upper edge, rear side, or bottom edge of the said left case half;
The said right case half is of one-piece plastic construction, with another said soft rubber pad covering the upper edge, rear side, or bottom edge of the said right case half;
One said metal case panel is single section of thin sheet metal unitarily contoured by pressure forming and the said metal case panel is affixed to the exterior side of the said left case half;
One said metal case panel is single section of thin sheet metal unitarily contoured by pressure forming and the said metal case panel is affixed to the exterior side of the said right case half:

2. As mentioned in claim 1 of improved structure tape rule outer housing of the invention herein, the surfaces of the said metal panels can be reticulated.

3. As mentioned in claim 1 of improved structure tape rule outer housing of the invention herein, a single said metal panel can also be affixed along the center upper edges of the said left case half and the said right case half.
